(19) United States
(12) Patent Application Publication
(10) Pub. No.: US 2024/0418604 A1
(43) Pub. Date: Dec. 19, 2024

(54) ROLLING TEST-CONTROLLED DRESSING

(71) Applicant: Klingelnberg AG, Zürich (CH)

(72) Inventors: Alexander Landvogt, Rheinstetten (DE); Thomas Serafin, Karlsruhe (DE); Sebastian Stramm, Köln (DE)

(21) Appl. No.: 18/742,575

(22) Filed: Jun. 13, 2024

(30) Foreign Application Priority Data
Jun. 16, 2023 (DE) 10 2023 115 778.7

(51) Int. Cl. G01M 13/021; B23F 21/02

(52) U.S. Cl. CPC G01M 13/021; B23F 21/026

(57) ABSTRACT

A method including the following steps of: grinding a number of toothed components using a dressable grinding tool; carrying out a rolling test of two or more of the toothed components; dressing of the grinding tool, wherein a dressing requirement of the grinding tool is determined prior to dressing; and wherein the dressing requirement of the grinding tool is determined on the basis of results of the rolling test of the two or more components.

The present invention relates to a method comprising the method steps of: grinding a plurality of toothed components by means of a dressable grinding tool; carrying out a rolling test of two or more of the toothed components; dressing the grinding tool, wherein a dressing requirement of the grinding tool is determined prior to dressing.

The rolling test of toothed components is used for quality assurance. In particular, the rolling test can be used to check rotational errors and noise behavior of the gearing. In the series production of toothed components, test standes are used to diagnose rotational errors and noise, wherein up to 100% of the manufactured components are tested, depending on manufacturer or customer specifications. As part of the widespread process chain of pre-gearing-hardening-grinding, the rotational error and noise test therefore represents a quality control after hard finishing by grinding.

It is also known to test a toothing within a gearbox, wherein such a test is referred to as an “end-of-line test” (EOL test). Here, the gearing to be tested is installed in a gearbox housing that is assigned to or comparable with the gearbox actually delivered. This EOL test tests the gearing under the most realistic operating conditions possible, wherein the EOL test can take place on a gearbox test stand, for example. The gearbox test stand simulates, for example, the operating conditions or the expected operating loads.

The testing of a gearing on a rolling test stand therefore differs from the EOL test in particular in that the gearing is tested on its own without being installed in a gear housing that reflects the real, fully assembled state.

In many cases, a gearing is ground using a dressable grinding tool, such as a dressable grinding wheel or a dressable grinding worm. These dressable grinding tools essentially consist of cutting particles or abrasive grit, such as corundum or similar, which are embedded in a ceramic bond or synthetic resin bond, for example. The bond is also called a matrix. The dressable volume of such an abrasive tool therefore consists of the matrix material, the abrasive grain bound therein and pores in the matrix.

With increasing use, the dressable grinding tool loses its original shape due to wear. Furthermore, the external abrasive grains become blunt due to the grinding contact and the pores and grain spaces can become clogged with impurities. The purpose of dressing the grinding tool is to sharpen the grinding tool in question and restore the intended profile shape of the grinding tool. The grinding wheel is therefore brought back into the required geometric shape. In addition, the grain layers that have become blunt are removed, sharp or cutting grain layers are exposed and, as a result, impurities are also removed.

A particular challenge when dressing is to choose the best possible time to dress the grinding tool. Dressing too early means wasting the usable volume of the grinding tool. The abrasive grain of the grinding tool is therefore not optimally utilized and fewer components are produced with the grinding tool in question than the grinding tool would allow.

Dressing too late can lead to overloading and damage to the grinding tool, which can make the grinding tool unusable overall. In addition, dressing too late can result in the production of defective parts, as grinding burn occurs on the machined surfaces, for example, or the grinding tool no longer has the required removal rate during the grinding process. A wear-related faulty geometry of the grinding tool can also lead to the production of a faulty geometry on the ground components. Furthermore, the desired surface roughness of the ground tooth flanks may not be achieved.

In case of doubt, dressing too early is therefore preferable to dressing too late, as damage to the grinding tool and the production of bad parts should be avoided in any case. In operational practice, the dressing intervals are therefore usually estimated to be on the safe side, i.e. too short rather than too long.

One method for determining the dressing requirement is to monitor the condition of the grinding tool using tactile or optical measuring methods. Dressing is carried out depending on the results of the tactile or optical measurement. The dressing requirement is therefore determined on the basis of tool wear measured on the grinding tool itself. The dressing cycles are therefore determined based on the grinding tool.

Another approach is to trigger dressing after a specified number of machined components. This is often based on empirical values. This means that the dressing cycles are determined as a function of the total volume machined by the grinding tool on the workpieces, wherein a dressing requirement is assigned to the machined volume based on empirical values. The dressing cycles are therefore determined on the basis of the machined volume.

In both of the aforementioned cases, however, there is a risk that abrasive grain will be wasted, as the grinding tool in question may still be able to produce good parts. The available volume of the grinding tool or the abrasive grain of the grinding tool may not be optimally utilized.

Against this background, the present invention is based on the technical problem of specifying a method which enables a dressable grinding tool to be used as efficiently as possible.

The technical problem described above is solved with the features of the independent claim. Further embodiments of the invention result from the dependent claims and the following description.

The invention relates to a method comprising the method steps: grinding at least one toothed component by means of a dressable grinding tool; carrying out a rolling test of the at least one toothed component; dressing the grinding tool, wherein a dressing requirement of the grinding tool is determined prior to dressing. The method is characterized in that the dressing requirement of the grinding tool is determined on the basis of at least one result of the rolling test.

The invention is based on the idea that the dressing requirement is not based on the grinding tool or the machined volume, but on the ground component or the component quality. This is because as long as the grinding tool in question produces good parts within the specified quality criteria, no dressing should be necessary. For this purpose, data or results can be used that are determined during the rolling test of at least one toothed component. Since in many cases the rolling test is already part of the quality inspection, the method according to the invention can be implemented in these cases without the purchase of additional machines.

It may be provided to grind a plurality of toothed components using a dressable grinding tool.

It may be provided to carry out a rolling test on two or more of the toothed components.

It may be provided that the dressing requirement of the grinding tool is determined on the basis of the results of the rolling test of the two or more components.

Overall, the method according to the invention enables in particular an optimized and dynamic determination of the dressing requirement, wherein the dressing requirement is determined based on the component or the component quality. In this way, dressing too early or too late can be avoided. A “dynamic determination of the dressing requirement” means that the dressing requirement can be determined separately for each dressing cycle. While the dressing requirement may already be necessary after a first, smaller number of ground components after a first dressing, the dressing requirement after a second dressing may only be necessary after a second, larger number of ground components. This is because the grinding process and tool wear are not necessarily constant over the entire service life of the grinding tool, but can be influenced by factors such as temperature fluctuations, coolant supply, vibrations and the like.

If the component quality decreases rapidly, for example, dressing can be initiated earlier, while dressing can take place later if a stable component quality is observed—in each case assessed on the basis of the results of the rolling test.

Grinding the toothed component is gear grinding. This means that the toothed component has a gearing that is ground using the grinding tool.

The rolling test of the toothed component is a rolling test of the gearing of the toothed component.

The dressable grinding tool is dressed in particular by means of a dressing tool, such as a form dresser, a point dresser or the like.

When it is stated here that the grinding tool requires dressing, this can mean in particular that the grinding tool must be dressed before the next toothed component is ground in order to avoid the production of bad parts or rejects. Rejects or bad parts are toothed components that do not meet the required quality specifications.

For example, when checking the most recently manufactured 15 components, it can be determined that, based on the results of the respective rolling test of these components, the 17^{th}, 18^{th} or 19^{th} manufactured toothed components will probably no longer meet the required quality specifications. This is because the results of the rolling test can be used, for example, to extrapolate a trend in the deterioration of one or more parameters of the rolling test in order to predict from which point in time bad parts would probably be produced using the grinding tool.

The results of the rolling test therefore indirectly reflect the condition of the dressable grinding tool, in particular the wear of the dressable grinding tool, wherein the wear of the dressable grinding tool is assessed in the present case on the basis of the ability of the dressable grinding tool to produce good parts, With regard to this criterion of the rolling test, a dressable grinding tool is therefore not considered worn or to be dressed if wear measured on the grinding tool itself is detected, but if the grinding tool is no longer suitable for grinding toothed components within the required quality specifications.

When it is stated here that the grinding tool requires dressing, this can mean in particular that the grinding tool must be dressed before the next toothed component is ground and after at least one toothed component has been produced that does not meet the required quality specifications. This component, which does not meet the required quality specifications, can be reworked if necessary in order to meet the required quality specifications and can, for example, be ground again in particular. With the procedure described above, the dressing cycles can be utilized to the maximum, wherein a reject of a less toothed component may be accepted.

It may be provided that, in order to determine the dressing requirement, optical and/or tactile measuring methods are used to check the condition of the dressable grinding tool in addition to taking into account the results of the rolling test. In particular, such supplementary optical and/or tactile measuring methods can be used to correlate tool wear measured on the dressable grinding tool with the results of the rolling test and/or to detect macroscopic defects of the dressable grinding tool, such as breakouts on the cutting flanks or on the head of the grinding tool profile, which could lead to destruction of the dressable grinding tool.

When a toothed component is referred to in the present case, it may in particular be a gearwheel or a toothed shaft, such as gearwheels or toothed shafts with helical gearing or spur gearing, worm wheels or worms, bevel gears or the like.

It is possible that the rolling test is carried out using a test stand. This involves carrying out a practical quality test on the toothed components in question. In particular, the test stand is a test stand for the rolling test and noise diagnosis of gearings.

It may be provided that the results of the rolling test, which has been carried out using the test stand, are checked using analysis software. It may be provided that the dressing requirement of the grinding tool is determined by means of the analysis software. In particular, the analysis software can be used to check whether one or more absolute values of certain quality parameters determined during the rolling test exceed a respectively predetermined limit value and/or whether a change in one or more quality parameters measured from component to component exceeds a predetermined limit value. A comparison of the results from component to component therefore means that the results of the rolling test of the components concerned are compared with each other in chronological order of their production in order to identify trends in the changes in the quality parameters taken into account in the rolling test.

In addition to considering absolute values, relative reference values can also be used to evaluate trends and/or changes in the quality parameters of the rolling test. For example, a toothed component that meets the quality specifications particularly well can serve as a reference, and a dressing requirement can be determined according to whether other toothed components are within a specified deviation corridor with regard to this reference or whether there is or threatens to be too great a deviation from this reference.

According to one embodiment of the method, it may be provided that the rolling test is carried out on a software basis by means of evaluation software, wherein measurement data of the geometry of the respective ground component are input data of the software-based rolling test. The software-based rolling test virtually simulates the test stand test of a practical rolling test. For example, a virtual twin of the component to be tested can be created on the basis of measurement data of the geometry of the ground component to be subjected to the software-based rolling test, which rolls, for example, with a virtual master wheel as part of the software-based rolling test. It is understood that the analysis can also be carried out purely numerically. In this way, rotational errors can be determined virtually, which are comparable with the rotational errors measured in practical tests. Both the single flank rolling test and the double flank rolling test can be simulated virtually or calculated on the basis of measured geometric deviations.

The measurement data of the geometry of the respective ground component can be determined by means of a coordinate measuring machine, in particular by tactile and/or optical measurement. This can, for example, be a coordinate measuring machine with a rotary table, wherein the gearing to be measured is held on the rotary table and can be rotated about its own axis by means of the rotary table during the measurement.

It may be provided that the results of the software-based rolling test, which has been carried out using the evaluation software, are checked using analysis software. It may be provided that the dressing requirement of the grinding tool is determined by means of the analysis software. In particular, the analysis software can be used to check whether one or more absolute values of certain quality parameters determined during the rolling test exceed a predetermined limit value and/or whether a change in one or more quality parameters measured from component to component exceeds a predetermined limit value. A comparison of the results from component to component therefore means that the components concerned are compared with each other in chronological order of their production in order to identify trends in the changes in the quality parameters taken into account in the rolling test.

In addition to considering absolute values, relative reference values can also be used to evaluate trends and/or changes in the quality parameters of the rolling test. For example, a toothed component that meets the quality specifications particularly well can serve as a reference and a dressing requirement can be determined according to whether other toothed components are within a specified deviation corridor with regard to this reference or whether there is or threatens to be too great a deviation from this reference.

According to one embodiment of the method, the rolling test has a rotational error analysis, wherein the dressing requirement is present if at least one result of the rotational error analysis exceeds a predetermined limit value and/or a change in at least one result of the rotational error analysis exceeds a predetermined limit value when viewed from component to component. As previously mentioned, the consideration from component to component means a chronological consideration of the successively manufactured components in order to recognize trends in the change of the rotational error within the scope of the rotational error analysis. Alternatively or additionally, it may be provided that absolute values can be taken into account as part of the rotational error analysis, wherein exceeding a limit value for such an absolute value can also mean that dressing is required.

The dressing requirement may be present if a quality criterion, which is determined from one or more results of the rotational error analysis, is not fulfilled. For example, key figures can be determined that are calculated from one or more results of the rotational error analysis, wherein value ranges for these key figures can form a quality criterion.

It may be provided that the rolling test includes a single flank rolling test.

According to one embodiment of the method, the dressing requirement is present if an assigned, predetermined limit value is exceeded for one or more of the results of the single flank rolling test listed below and/or the dressing requirement is present if a change measured from component to component exceeds a predetermined limit value for one or more of the results of the single flank rolling test listed below: radial runout, rolling deviation, runout error, tooth-to-tooth amplitude, maximum rolling deviation, transmission error and dynamic backlash, noise behavior, surface defects.

It may be provided that the rolling test comprises a double flank rolling test.

According to one embodiment of the method, the dressing requirement is present if an assigned, predetermined limit value is exceeded for one or more of the results of the double flank rolling test listed below and/or the dressing requirement is present if a change measured from component to component exceeds a predetermined limit value for one or more of the results of the double flank rolling test listed below: center distance, radial runout, rolling jump, rolling deviation, two-ball dimension, noise behavior.

The noise test can include the recording of structure-borne noise and/or airborne noise as part of the rolling test. This data can also be checked for exceeding absolute values and/or for changes measured from component to component and used to determine the dressing requirement.

The methods of rolling contact testing with rotational error analysis, or in particular single flank rolling contact testing and double flank rolling contact testing, are state of the art and are well known. The core of the invention is not the rolling test or the single flank rolling test or the double flank rolling test, but the use of the results of such a rolling test, in particular the single flank rolling test or the double flank rolling test, in order to determine the dressing requirement of a dressable grinding tool. The invention therefore relates in particular to rolling test-controlled dressing, wherein the term “rolling test-controlled” relates to the recognition of the dressing requirement and the dressing process itself is not controlled by the rolling testing. It may therefore also be possible to speak of rolling test-triggered dressing, as the results of the rolling test trigger the dressing of the dressable grinding tool or the dressing requirement is determined on the basis of the results of the rolling test.

The invention is described in more detail below with reference to drawings illustrating exemplary embodiments, wherein the drawings show schematically in each case:

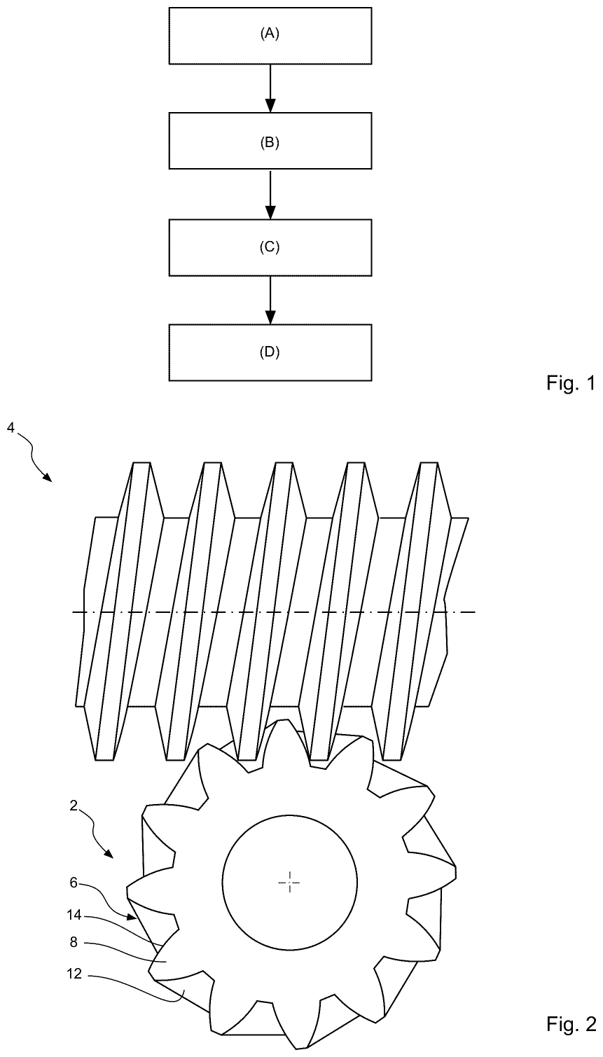

FIG. 1 shows a flow chart of the method according to the invention;

FIG. 2 shows a grinding worm with a gearwheel;

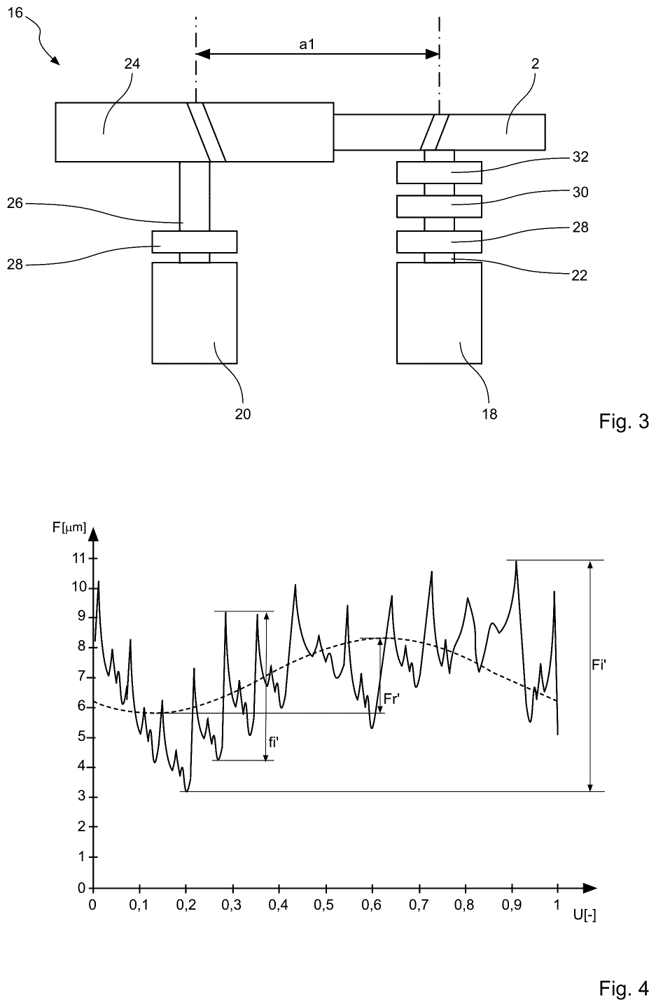

FIG. 3 shows a single flank rolling test;

FIG. 4 shows a result of the single flank rolling test;

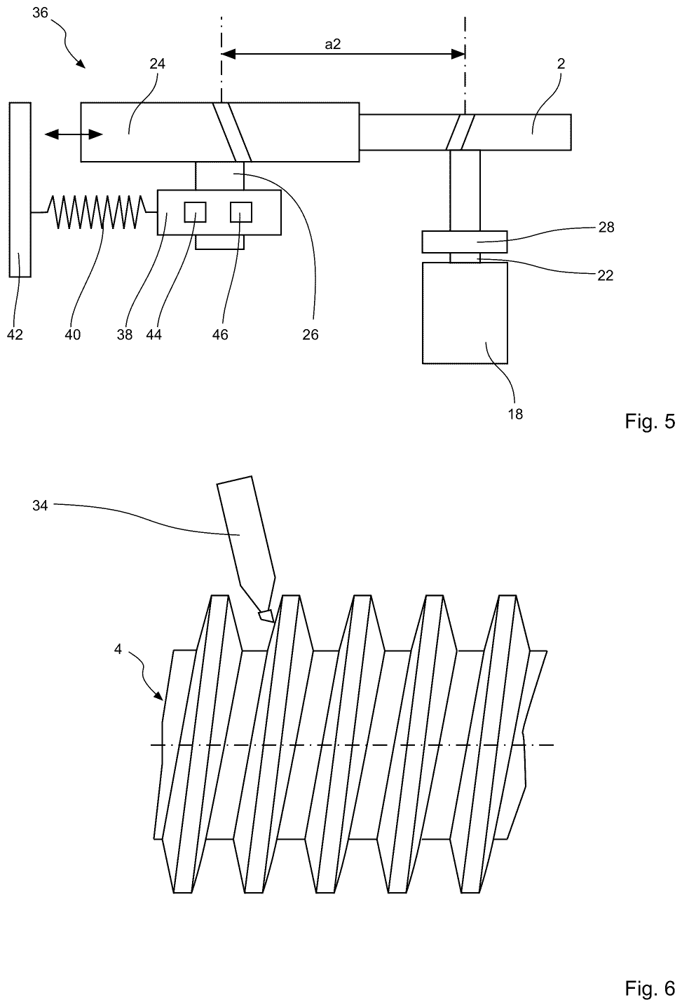

FIG. 5 shows a double flank rolling test;

FIG. 6 shows a dressing of the grinding worm from FIG. 2.

FIG. 1 shows a flow chart of the method according to the invention. The method steps (A), (B), (C), (D) are shown here in sequence for simplified illustration, but can also take place partially in parallel, i.e. at least partially simultaneously.

In method step (A), a plurality of toothed components 2 are ground using a dressable grinding tool 4. FIG. 2 shows an example of both one of the toothed components 2 and the dressable grinding tool 4.

The toothed component 2 is an external helical-toothed spur gear. According to alternative embodiments, the toothed component can be a bevel gear. The toothed component is part of a running toothing for power transmission with speed and torque transmission or reduction, wherein the design of the toothed component is not relevant for the method according to the invention. The method according to the invention can therefore be used for both spur gears and bevel gears. By way of example and representation, the following explanations refer to components in the form of the external helical-toothed spur gear 2.

The spur gear 2 has a gearing 6, with teeth 8 and tooth spaces 10 formed between them. The teeth 8 each have tooth flanks 12, 14, which are ground by grinding using the grinding tool 4. The grinding tool 4 is a dressable grinding tool—in this case a dressable grinding worm. According to alternative exemplary embodiments, the grinding tool can be a dressable grinding wheel or a cup grinding wheel.

In method step (B), a rolling test is carried out on two or more of the toothed components 2. FIG. 3 shows an example of the schematic structure of a test stand 16 for carrying out a single flank rolling test for a respective toothed component 2.

The test stand 16 has a first drive 18 and a second drive 20. The first drive 18 is set up to drive a first shaft 22, on which the toothed component 2 to be tested is mounted.

The second drive 20 is used to brake a mating gear 24, which is mounted on a second shaft 26 coupled to the drive 20.

The mating gear 24 is an externally toothed spur gear that meshes with the gearing of component 2. By driving the toothed component 2 and simultaneously braking the mating gear 24, a speed and a torque can be set during the test run. It is understood that speed and torque curves can also be adjusted. A center distance a1 between the shafts 22, 26 is constant.

The test stand 16 has rotary encoders or angle measuring systems 28, a rotational acceleration sensor 30 and a structure-borne sound sensor 32.

FIG. 4 shows a schematic example of the measured rotational error F in [μm] plotted over one revolution U of the gearwheel 2—i.e. a result of a single flank rolling test of a single toothed component 2. From this, values for the first-order runout error Fr′, the tooth-to-tooth amplitude fi′ and the maximum rolling deviation Fi′, for example, can be determined in a known manner. The rolling test is performed and evaluated for two or more components 2.

In method step (C), a dressing requirement of the grinding tool 4 is determined using the results of the rolling test of the two or more toothed components 2. If the dressing requirement is present, the grinding tool is dressed in method step (D).

Dressing is shown schematically in FIG. 6. A dresser 34 is brought into engagement with the grinding tool 4 and the grinding tool 4 is dressed, i.e. re-profiled to its intended target geometry.

Dressing is required, for example, if a predetermined limit value is exceeded for one or more of the aforementioned results of the single flank rolling test, i.e. the first-order runout error Fr′, the tooth-to-tooth amplitude fi′ and the maximum rolling deviation Fi′, and/or a change in such a result measured from component to component exceeds a predetermined limit value.

During the single flank rolling test, there is a single flank contact between the gearing 4 to be tested and the mating gear 24, i.e. either the left-hand flanks or the right-hand flanks of the toothed component 2 roll with the mating gear 24—at a constant center distance a1.

Alternatively or additionally, a double flank rolling test can be carried out in method step (B). A test stand 36 for the double flank rolling test is shown as an example in FIG. 5. To avoid repetition, the same reference signs are assigned to the same features in the following.

The double flank rolling test differs essentially from the single flank rolling test described above with reference to FIG. 3 in that a center distance a2 is not constant during the test. The mating gear 24 is mounted and supported with its shaft 26 on a movable carriage 38. The movable carriage 38 is supported by means of a spring device 40 on an immovable counterholder 42.

By means of the spring device 40, the mating gear 24 is pressed into tooth contact with the gearing 4 to be tested, wherein there is contact on both sides of the right and left flanks of the gearing 4 to be tested in the tooth contact.

During the test, i.e. during the rolling of the component 2 with the mating gear 24, the mating gear 24 is pressed with a defined force in the direction of the component 2. The deviation is recorded by means of a translational displacement of the movable carriage 38, wherein a displacement transducer 44 and a vibration transducer 46 are assigned to the carriage 38 in order to record measurement data. The results of the double flank rolling test are, for example, the rolling runout deviation, the double flank rolling deviation and the double flank rolling jump. The results of the double flank rolling test can in turn be used in method step (C) to determine the dressing requirement, i.e. to check whether the grinding tool needs to be dressed or whether the grinding tool is still capable of producing good parts.

As already mentioned, the methods of the single flank rolling test and the double flank rolling test are known. The invention aims to use the results of the single flank rolling test and/or the double flank rolling test to determine the dressing requirement of a grinding tool.

### LIST OF REFERENCE SIGNS

4 Toothed component
6 Gearing
8 Tooth
12 Tooth flank
14 Tooth flank
16 Test stand
18 First drive
20 Second drive
22 First shaft
24 Mating gear
26 Second shaft
28 Rotary encoder/angle measuring system
30 Rotational acceleration sensor
32 Structure-borne sound sensor
34 Dresser
36 Test stand
38 Carriage
40 Spring device
42 Counterholder
44 Displacement transducer
46 Vibration transducer
(A) Method step
(B) Method step
(C) Method step
(D) Method step
a1 Center distance
a2 Center distance

1. A method having the following steps of:
grinding of at least one toothed component using a dressable grinding tool;
carrying out a rolling test of the at least one toothed component;
dressing of the grinding tool, wherein a dressing requirement of the grinding tool is determined prior to dressing;
wherein the dressing requirement of the grinding tool is determined on the basis of at least one result of the rolling test.

2. The method according to claim 1,
further including the step of grinding a plurality of toothed components using the dressable grinding tool.

3. The method according to claim 2,
further including the step of
carrying out the rolling test on two or more of the toothed components.

4. The method according to claim 3,
wherein the dressing requirement of the grinding tool is determined on the basis of the results of the rolling test of two or more components.

5. The method according to claim 1,
wherein the rolling test is carried out using a test stand and/or
the rolling test is carried out on a software basis using an evaluation software, wherein measurement data of the geometry of the respective ground component are input data of the software-based rolling test.

6. The method according to claim 1,
wherein the rolling test has a rotational error analysis, wherein the dressing requirement is present if at least one result of the rotational error analysis exceeds a predetermined limit value,
and/or
in that the dressing requirement is present if a quality criterion, which is determined from one result or from a plurality of results of the rotational error analysis, is not fulfilled.

7. The method according to claim 3,
wherein the rolling test has a rotational error analysis, wherein the dressing requirement is present if a change in at least one result of the rotational error analysis exceeds a predetermined limit value when viewed from component to component.

8. The method according to claim 1,
wherein the rolling test comprises a single flank rolling test.

9. The method according to claim 8,
wherein the dressing requirement is present if an assigned, predetermined limit value is exceeded for one or more of the results of the single flank rolling test listed below and/or the dressing requirement is present if a predetermined limit value is exceeded for a result: radial runout, rolling deviation, runout error, tooth-to-tooth amplitude, maximum rolling deviation, transmission error and dynamic backlash, noise behavior, surface defects.

10. The method according to claim 3,
wherein the rolling test comprises a single flank rolling test; and
the dressing requirement is present if a change measured from component to component exceeds a predetermined limit value for one or more of the results of the single flank rolling test listed below: radial runout, rolling deviation, runout error, tooth-to-tooth amplitude, maximum rolling deviation, transmission error and dynamic backlash, noise behavior, surface defects.

11. The method according to claim 1,
wherein the rolling test comprises a double flank rolling test.

12. The method according to claim 11,
wherein the dressing requirement is present if an assigned, predetermined limit value is exceeded for one or more of the results of the double flank rolling test listed below: center distance, radial runout, rolling jump, rolling deviation, two-ball dimension, noise behavior.

13. The method according to claim 3,
wherein the rolling test comprises a double flank rolling test; and the dressing requirement is present if a change measured from component to component exceeds a predetermined limit value for one or more of the results of the double flank rolling test listed below: center distance, radial runout, rolling jump, rolling deviation, two-ball dimension, noise behavior.

14. The method according to claim 1,
wherein results of the rolling test, which has been carried out using the evaluation software, are checked using an analysis software, wherein the dressing requirement of the grinding tool are determined in particular using the analysis software.

15. The method according to claim 1,
wherein the analysis software is used to check whether one or more absolute values of certain quality parameters determined during the rolling test exceed a predetermined limit value and/or whether a change in one or more quality parameters measured from component to component exceeds a predetermined limit value.
